(19) United States
(12) Patent Application Publication
(10) Pub. No.: US 2025/0330085 A1
(43) Pub. Date: Oct. 23, 2025

(54) Power converter and related control circuit with double injection control

(71) Applicant: NOVATEK Microelectronics Corp., Hsin-Chu (TW)

(72) Inventors: Chieh-Ju Tsai, Kinmen County (TW); Yu-Ting Hung, Taipei City (TW); Ching-Jan Chen, Taipei City (TW); Chan-Hsuan Hsu, Taipei City (TW); Chun-Yu Hsieh, Miaoli County (TW)

(73) Assignee: NOVATEK Microelectronics Corp., Hsin-Chu (TW)

(21) Appl. No.: 19/006,255

(22) Filed: Dec. 31, 2024

Related U.S. Application Data
(60) Provisional application No. 63/635,628, filed on Apr. 18, 2024.

(51) Int. Cl. H02M 3/157; H02M 1/00; H02M 3/158

(52) U.S. Cl. CPC H02M 3/157; H02M 1/0025; H02M 3/158

(57) ABSTRACT

A control circuit for a power converter includes a ramp generator, an operation circuit and a comparator, wherein the power converter has an input voltage and an output voltage. The ramp generator is configured to receive the input voltage or the output voltage to generate a ramp voltage. The operation circuit is configured to generate a second error voltage according to a computation result of a first error voltage and the input voltage, wherein the first error voltage is generated from the output voltage. The comparator, coupled to the ramp generator and the operation circuit, is configured to compare the second error voltage with the ramp voltage to generate a control signal.

### CROSS REFERENCE TO RELATED APPLICATIONS

This application claims the benefit of U.S. Provisional Application No. 63/635,628, filed on Apr. 18, 2024. The content of the application is incorporated herein by reference.

### BACKGROUND OF THE INVENTION

### 1. Field of the Invention

The present invention relates to a power converter, and more particularly, to a power converter with double injection control.

### 2. Description of the Prior Art

Power converters are widely used in various electronic systems, to provide a stable voltage supply. The power converters may include the switching-capacitor type and switching-inductor type, to meet different requirements such as power efficiency, stability, or for different load magnitudes. A hybrid converter is a type of power converter that applies an inductor with a capacitor in the power stage. Since the hybrid converter has a flying capacitor, the same output power may be achieved by using a smaller inductor, thereby improving the power density and reducing the circuit cost.

In general, a hybrid converter applies a voltage mode control technique, where a feedback circuit is deployed to generate control signals for switching the switch elements in the power converter to generate a desired level of the output voltage. The voltage mode control is usually suffered from a line transition problem, where an overshoot or undershoot may generate in the output voltage when the input voltage changes. Thus, there is a need for improvement over the prior art.

### SUMMARY OF THE INVENTION

It is therefore an objective of the present invention to provide a novel power converter and its control circuit using a double injection technique, to solve the line transition problem of the power converter.

An embodiment of the present invention discloses a control circuit for a power converter, wherein the power converter has an input voltage and an output voltage. The control circuit comprises a ramp generator, an operation circuit and a comparator. The ramp generator is configured to receive the input voltage or the output voltage to generate a ramp voltage. The operation circuit is configured to generate a second error voltage according to a computation result of a first error voltage and the input voltage, wherein the first error voltage is generated from the output voltage. The comparator, coupled to the ramp generator and the operation circuit, is configured to compare the second error voltage with the ramp voltage to generate a control signal.

Another embodiment of the present invention discloses a power converter, which comprises a power stage and a control circuit. The power stage is configured to receive an input voltage to generate an output voltage. The control circuit, coupled to the power stage, comprises a ramp generator, an operation circuit and a comparator. The ramp generator is configured to receive the input voltage or the output voltage to generate a ramp voltage. The operation circuit is configured to generate a second error voltage according to a computation result of a first error voltage and the input voltage, wherein the first error voltage is generated from the output voltage. The comparator, coupled to the ramp generator and the operation circuit, is configured to compare the second error voltage with the ramp voltage to generate a control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power converter.

FIG. 2A illustrates the line transition problem accompanied by the voltage mode control.

FIG. 2B illustrates increasing the height of the ramp voltage when the input voltage rises.

FIG. 2C illustrates modifying or adjusting the error voltage in the double injection scheme.

FIG. 3 is a schematic diagram of a power converter according to an embodiment of the present invention.

FIG. 4 is a schematic diagram of a detailed implementation of the control circuit according to an embodiment of the present invention.

FIG. 5 is a waveform diagram of a comparison between the proposed double injection control and the general voltage mode control for the power converter.

FIG. 6 is a schematic diagram of a detailed implementation of the power converter according to an embodiment of the present invention.

FIG. 7 is a schematic diagram of the control circuit applied to a hybrid buck converter according to an embodiment of the present invention.

### DETAILED DESCRIPTION

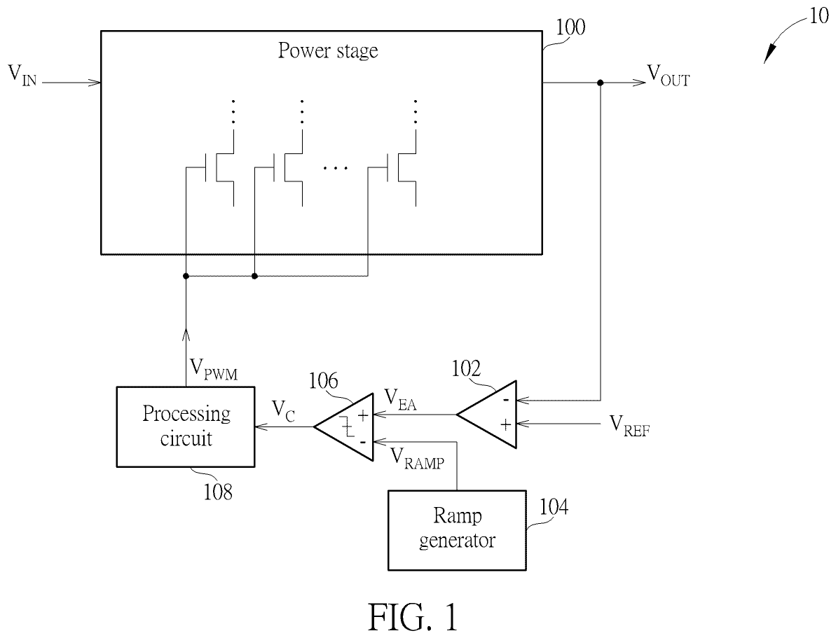

FIG. 1 is a schematic diagram of a power converter 10. The power converter 10 includes a power stage 100. The power stage 100, which may be composed of a power element and several switches, is configured to receive an input voltage V_{IN} to generate an output voltage V_{OUT}. Based on whether the power converter 10 is the switching-capacitor type or switching-inductor type, the power element may be a capacitor or an inductor. In order to realize a hybrid converter, there may be multiple power elements in the power stage 100, including a capacitor and an inductor.

In order to control the power converter 10 to generate a stable output voltage V_{OUT}, the power converter 10 may apply a voltage mode control scheme by using a feedback circuit, which includes an error amplifier 102, a ramp generator 104, a comparator 106 and a processing circuit 108. The error amplifier 102 may receive the output voltage V_{OUT} and a reference voltage V_{REF} to generate an error voltage V_{EA}. Through well design of the reference voltage V_{REF}, the output voltage V_{OUT} may be controlled to keep at a desired level. The ramp generator 104 may generate a ramp voltage V_{RAMP} and provide the ramp voltage V_{RAMP} to the comparator 106. The comparator 106 may compare the error voltage V_{EA} with the ramp voltage V_{RAMP} to generate a control signal V_{C}, which is received by the processing circuit 108. According to the control signal V_{C}, the processing circuit 108 may generate one or more pulse width modulation (PWM) signals V_{PWM} with an appropriate duty cycle, to control the on/off operations of the switches in the power stage 100, so as to adjust the output voltage level of the power converter 10. In several embodiments, the processing circuit 108 may also be used to realize various functions to improve the performance of switch control, such as soft start and dead-time control.

As mentioned above, the line transition problem appears with transitions of the input voltage V_{IN}. When the input voltage V_{IN} changes its level, the output voltage V_{OUT} may rapidly follow the input voltage V_{IN} to change. The feedback circuit of the power converter 10 may control the output voltage V_{OUT} to finally keep at a certain level, but the reaction speed of the feedback circuit is usually slower, causing the error voltage V_{EA} to be settled at a later time. In such a situation, the output voltage V_{OUT} may have a larger overshoot or undershoot, which is unfavorable in the circuit system that receives voltage supply from the power converter 10.

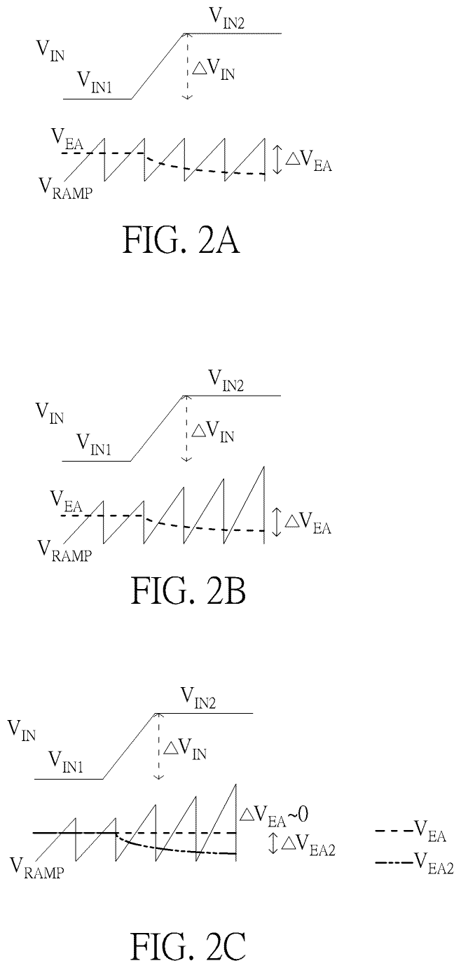

FIG. 2A illustrates the line transition problem accompanied by the voltage mode control, where the waveforms of the input voltage V_{IN} and the error voltage V_{EA} compared with the ramp voltage V_{RAMP} are shown. The input voltage V_{IN} rises from a first voltage level V_{IN1} to a second voltage level V_{IN2}, i.e., with a delta voltage ΔV_{IN}. In response to the transition of the input voltage V_{IN}, the error voltage V_{EA} falls by a delta voltage ΔV_{EA}, which modifies the duty cycle of the PWM signals V_{PWM} to decrease the output power, thereby making the output voltage return to its target level. However, the limitation of the loop bandwidth causes the error voltage V_{EA} to fall slower than the rising speed of the input voltage V_{IN}. This will generate a larger overshoot or undershoot in the output voltage V_{OUT} during the transition of the input voltage V_{IN}.

In an embodiment, in order to increase the speed of adjusting the duty cycle, the ramp generator 104 may be controlled to output the ramp voltage V_{RAMP} based on the level of the input voltage V_{IN}. For example, as shown in FIG. 2B, when the input voltage V_{IN} rises, the height of the ramp voltage V_{RAMP} may also increase, which means that the peak-to-peak magnitude of the ramp voltage V_{RAMP} increase, which in turn increases the settling speed of the duty cycle. Under an application of a boost converter, the duty cycle D may be expressed as:

$$D = \frac{{V}_{OUT} - {V}_{IN}}{{V}_{IN}} = \frac{{V}_{EA}}{{V}_{M}} ;$$

where V_{M} refers to a time average of the ramp voltage V_{RAMP}. Note that the duty cycle D should decrease when the input voltage V_{IN} increases. Although the overshoot or undershoot may be generated due to a slow settling of the error voltage V_{EA}, this output variation problem may still be improved with a timely change of the ramp voltage V_{RAMP} (or V_{M}).

However, in the embodiment of FIG. 2B, the error voltage V_{EA} is generated without any additional processing; hence, the error voltage V_{EA} may still change to a new value during line transition. This means that the improvement of overshoot or undershoot in the output voltage V_{OUT} is still limited.

Therefore, in another embodiment, a double injection technique is applied to further improve the line transition problem. Based on the implementation of the double injection, the error voltage to be output to the comparator may be modified with the input voltage, allowing the output of the error amplifier to keep constant.

For example, as shown in FIG. 2C, when the double injection scheme is applied, the error voltage V_{EA} output by the error amplifier may be modified or adjusted to generate a modified error voltage V_{EA2}, which may further be output to the comparator for comparison. The related calculation of the duty cycle D may be modified as follows:

$$D = \frac{{V}_{OUT} - {V}_{IN}}{{V}_{IN}} = \frac{{V}_{EA 2}}{{V}_{M}} = \frac{{V}_{EA} - {V}_{IN}}{{V}_{M}} .$$

Since the modified error voltage V_{EA2} received by the comparator has been decreased by a level of the input voltage V_{IN}, the error voltage V_{EA} output by the error amplifier may keep constant. As a result, the voltage variation in the output voltage V_{OUT} during line transition may be avoided.

As can be seen in the waveforms shown in FIG. 2C, when the input voltage V_{IN} increases, the modified error voltage V_{EA2} still falls (i.e., with a delta voltage ΔV_{EA2}) to decrease the duty cycle D to its target level, but the error voltage V_{EA} actually output by the error amplifier may substantially keep unchanged, which means that the delta voltage ΔV_{EA} is approximately 0.

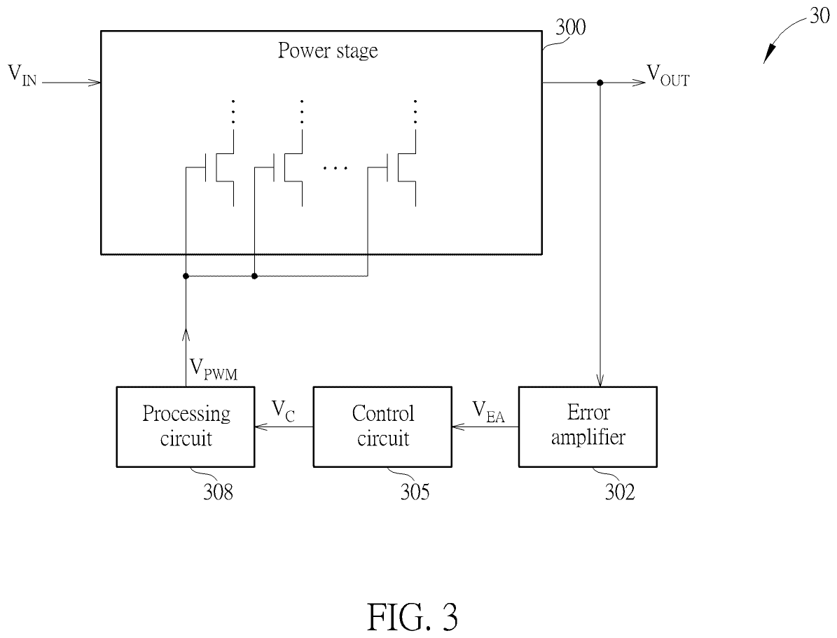

In order to realize the abovementioned control of the error voltage, a control circuit may be applied to the feedback loop of the power converter. FIG. 3 is a schematic diagram of a power converter 30 according to an embodiment of the present invention. The power converter 30 includes a power stage 300, an error amplifier 302, a control circuit 305 and a processing circuit 308. The circuit structures and operations of the power stage 300, the error amplifier 302 and the processing circuit 308 are similar to those of the power stage 100, the error amplifier 102 and the processing circuit 108, respectively, which are not repeated herein for brevity. The difference between the power converter 30 and the power converter 10 is that, the power converter 30 further includes the control circuit 305 for realizing the improvement of the above line transition problem.

As shown in FIG. 3, the control circuit 305 is implemented in the feedback circuit and coupled between the error amplifier 302 and the processing circuit 308, to receive the error voltage V_{EA} from the error amplifier 302, and correspondingly output the control signal V_{C} to the processing circuit 308. The control signal V_{C} may be used to control and adjust the duty cycle of the power converter 30, i.e., the duty cycle of the PWM signals V_{PWM} for controlling the power converter 30.

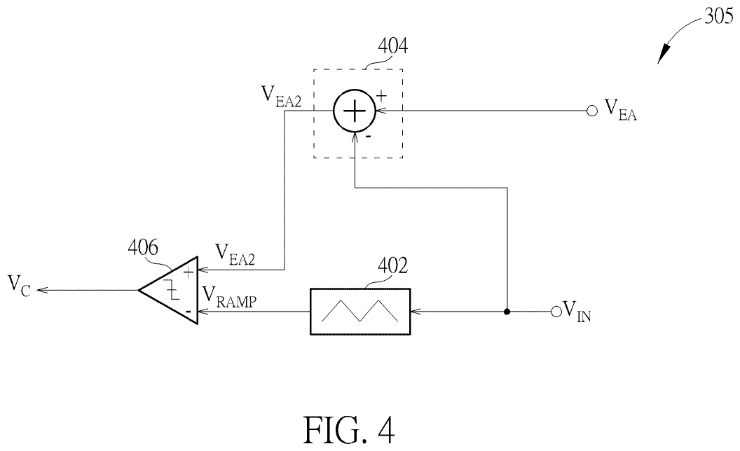

FIG. 4 is a schematic diagram of a detailed implementation of the control circuit 305 according to an embodiment of the present invention. The control circuit 305 includes a ramp generator 402, an operation circuit 404 and a comparator 406. In detail, the ramp generator 402 is configured to receive the input voltage V_{IN} to generate a ramp voltage V_{RAMP}. When the input voltage V_{IN} changes its level, the peak-to-peak amplitude of the ramp voltage V_{RAMP} may change accordingly, to increase the adjusting speed of the duty cycle, such as the implementation shown in FIG. 2B.

The operation circuit 404 is configured to receive the error voltage V_{EA} and the input voltage V_{IN}, to perform computation on these two voltages. According to the computation result of the error voltage V_{EA} and the input voltage V_{IN}, the operation circuit 404 may generate a modified error voltage V_{EA2}, which is further output to the comparator 406 for comparison. In various embodiments, the operation circuit 404 may include a subtractor, which subtracts the input voltage V_{IN} from the error voltage V_{EA} to generate the modified error voltage V_{EA2}. This structure of the control circuit 305 can realize the implementation shown in FIG. 2C, where the error voltage V_{EA} output by the error amplifier 302 may keep at a substantially constant level while the modified error voltage V_{EA2} may decrease to achieve the desired duty cycle.

Subsequently, the comparator 406 may compare the modified error voltage V_{EA2} with the ramp voltage V_{RAMP} to generate the control signal V_{C}, and output the control signal V_{C} to the processing circuit 308.

In the control circuit 305, the input voltage V_{IN} is injected to the ramp generator 402 to modify the magnitude of the ramp voltage V_{RAMP}, and also injected to the operation circuit 404 to modify the error voltage V_{EA}, thereby realizing the double injection control. The double injection scheme may enhance the reaction speed of the feedback loop in two aspects; that is, two injection points of the input voltage V_{IN}. This significantly improves the line transition problem caused by the change of the input voltage V_{IN}, which means that the variations of the output voltage V_{OUT} may be reduced.

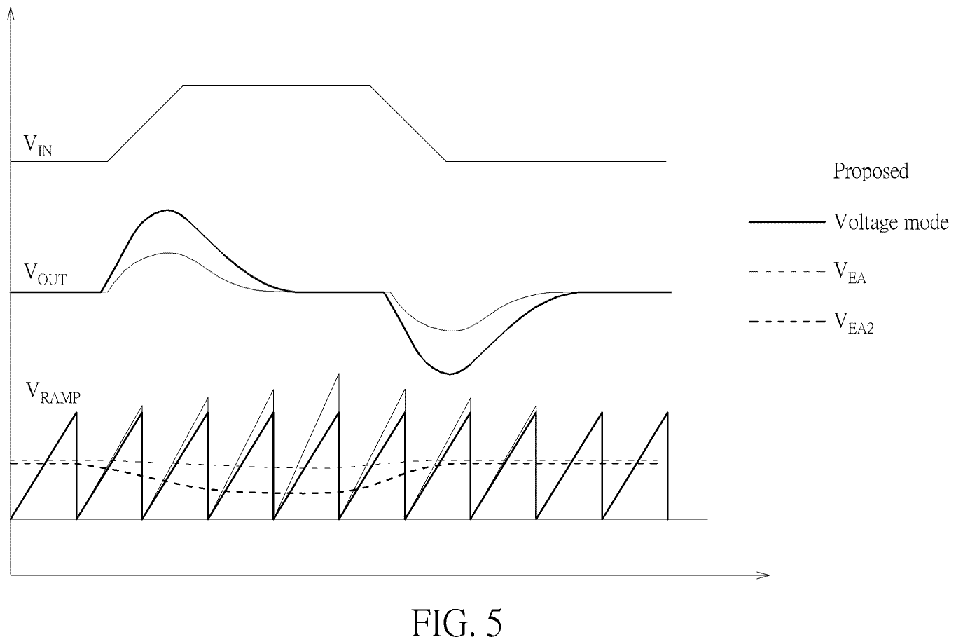

FIG. 5 is a waveform diagram of a comparison between the proposed double injection control and the general voltage mode control for the power converter, where the waveforms of the input voltage V_{IN}, the output voltage V_{OUT} and the comparison of the ramp voltage V_{RAMP} with the error voltages V_{EA} and V_{EA2} are shown. As shown in FIG. 5, when the input voltage V_{IN} changes, the proposed double injection control may achieve a more stable output voltage V_{OUT} with smaller variations as compared to the case of the general voltage mode control. Based on the double injection control, the ramp voltage V_{RAMP} may change in response to the transition of the input voltage V_{IN}, and the modified error voltage V_{EA2} decreases with the increase of the input voltage V_{IN}, to keep the error voltage V_{EA} output by the error amplifier at a substantially constant level.

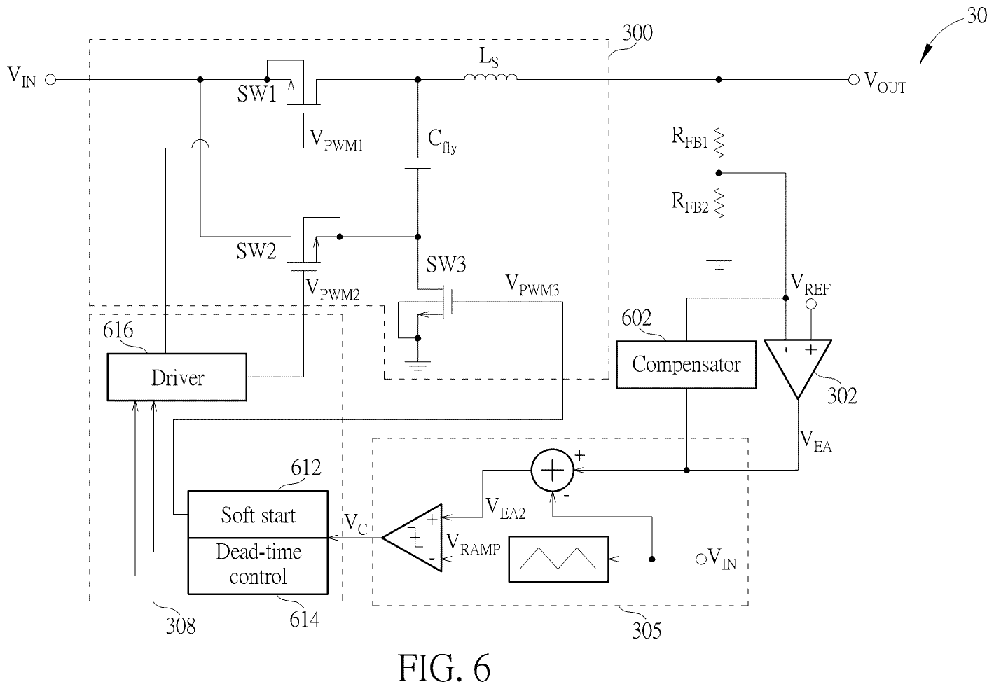

FIG. 6 is a schematic diagram of a detailed implementation of the power converter 30 according to an embodiment of the present invention. In this embodiment, the power converter 30 may be a KY boost converter, which includes a capacitor C_{fly} and an inductor L_{S} controlled by 3 switches SW1-SW3. FIG. 6 also illustrates a detailed implementation of the feedback circuit. In this embodiment, the output voltage V_{OUT} may first be divided by divider resistors R_{FB1} and R_{FB2} when entering the feedback circuit. The error amplifier 302 may be selectively deployed with a compensator 602, to improve the stability of the feedback loop. The control circuit 305 applies the same structure as shown in FIG. 4. The processing circuit 308 may include a soft start circuit 612, a dead-time control circuit 614, and a driver 616. The soft start circuit 612 may output a PWM signal V_{PWM} to the switch SW3, and may prevent the circuit elements of the power stage 300 from being damaged due to a rush current. The dead-time control circuit 614 may provide a timing control so that several of the switches SW1-SW3 will not be conducted simultaneously, thereby avoiding unwanted leakage currents. The driver 616 may provide appropriate driving signals (e.g., the PWM signals V_{PWM1} and V_{PWM2}) for the corresponding switches.

Note that the present invention aims at providing a novel control circuit for a power converter to reduce the overshoot and undershoot in the output voltage during transitions of the input voltage. Those skilled in the art may make modifications and alterations accordingly. For example, the circuit structure shown in FIG. 6 is merely one of various implementations of the power converter of the present invention, where the compensator 602 may apply any type of compensation or may be omitted, and/or the divider resistors R_{FB1} and R_{FB2} may be implemented in another manner or may be omitted. Further, the processing circuit may include any functions for improving the performance of the power converter, which are not limited to those described in this disclosure.

In addition, the double injection control method provided by the present invention may be applicable to any type of power converter, including but not limited to a hybrid converter, such as the KY boost converter in the above embodiment. In another embodiment, the double injection control method may be applied to a buck converter or a buck-boost converter, where the duty cycle may be determined differently with respect to the input voltage V_{IN} and the output voltage V_{OUT}. In such a situation, the ramp generator may receive the input voltage V_{IN} or the output voltage V_{OUT} to generate the variable ramp voltage V_{RAMP}. Based on the duty cycle formula, the operation circuit may perform calculation in an identical or different manner, e.g., with appropriate adding and/or subtraction, to control the error voltage V_{EA} output by the error amplifier to keep constant.

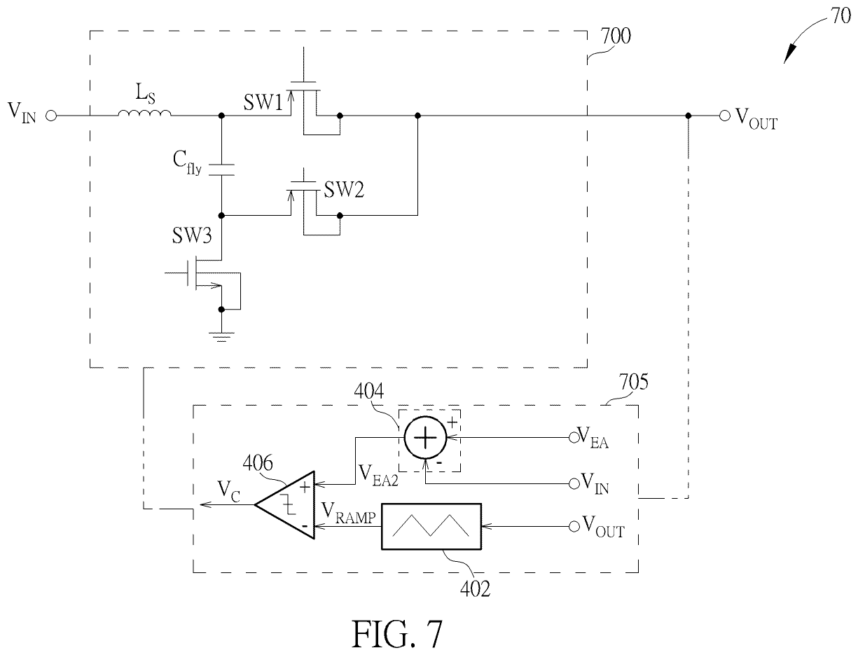

FIG. 7 is a schematic diagram of the control circuit applied to a hybrid buck converter 70 according to an embodiment of the present invention. The hybrid buck converter 70 includes a power stage 700 which is controlled by a control circuit 705. Other components of the hybrid buck converter 70 are similar to those described in the above paragraphs, which are omitted in FIG. 7 without influencing the illustrations of the present embodiment. The structure of the control circuit 705 is similar to the structure of the control circuit 305, so signals and elements having similar functions are denoted by the same symbols. The hybrid buck converter 70 also includes a capacitor C_{fly} and an inductor Lₛ controlled by 3 switches SW1-SW3.

In this embodiment, in order to be adapted to the duty cycle formula of the hybrid buck converter 70, the ramp circuit 402 receives the output voltage V_{OUT}, to change the magnitude of the ramp voltage V_{RAMP} according to the level of the output voltage V_{OUT}. The duty cycle D may be calculated as follows:

$$\frac{{V}_{OUT}}{{V}_{IN}} = \frac{1}{2 - D} ;$$

$$D = \frac{2 {V}_{OUT} - {V}_{IN}}{{V}_{OUT}} = \frac{{V}_{EA 2}}{{V}_{M}} = \frac{{V}_{EA} - {V}_{IN}}{{V}_{M}} .$$

The implementation of controlling the operations of the hybrid buck converter 70 using the duty cycle D is well known by a skilled person, and will be omitted herein.

To sum up, the present invention provides a double injection technique for a power converter. The feedback loop of the power converter may include a control circuit, where a comparator is used to compare a modified error voltage with a ramp voltage to generate a control signal with the desired duty cycle. The modified error voltage may be generated by an operation circuit and the ramp voltage may be generated by a ramp generator. An injection is applied to the operation circuit, which provides an appropriate logic calculation to control the error voltage output by the error amplifier to keep constant during line transition of the input voltage. Another injection is applied to the ramp generator, which changes the magnitude of the ramp voltage according to the level of the input voltage or the output voltage. As a result, the overshoot and undershoot in the output voltage during transitions of the input voltage may be mitigated, and the variation of the output voltage may be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit for a power converter, the power converter having an input voltage and an output voltage, the control circuit comprising:
a ramp generator, configured to receive the input voltage or the output voltage to generate a ramp voltage;
an operation circuit, configured to generate a second error voltage according to a computation result of a first error voltage and the input voltage, wherein the first error voltage is generated from the output voltage; and
a comparator, coupled to the ramp generator and the operation circuit, configured to compare the second error voltage with the ramp voltage to generate a control signal.

2. The control circuit of claim 1, wherein the operation circuit comprises a subtractor, which is configured to subtract the input voltage from the first error voltage to generate the second error voltage.

3. The control circuit of claim 1, wherein the control signal is used to control a duty cycle of the power converter.

4. The control circuit of claim 1, further being coupled to a processing circuit, which receives the control signal and generates a plurality of driving signals for controlling a plurality of switches in the power converter according to the control signal.

5. The control circuit of claim 1, further being coupled to an error amplifier, to receive the first error voltage from the error amplifier.

6. The control circuit of claim 5, wherein the error amplifier generates the first error voltage according to the output voltage.

7. The control circuit of claim 1, wherein the ramp generator changes a magnitude of the ramp voltage according to the input voltage or the output voltage.

8. The control circuit of claim 1, wherein the first error voltage substantially keeps unchanged during a transition of the input voltage.

9. A power converter, comprising:
a power stage, configured to receive an input voltage to generate an output voltage; and
a control circuit, coupled to the power stage, comprising:
a ramp generator, configured to receive the input voltage or the output voltage to generate a ramp voltage;
an operation circuit, configured to generate a second error voltage according to a computation result of a first error voltage and the input voltage, wherein the first error voltage is generated from the output voltage; and
a comparator, coupled to the ramp generator and the operation circuit, configured to compare the second error voltage with the ramp voltage to generate a control signal.

10. The power converter of claim 9, wherein the operation circuit comprises a subtractor, which is configured to subtract the input voltage from the first error voltage to generate the second error voltage.

11. The power converter of claim 9, wherein the control signal is used to control a duty cycle of the power converter.

12. The power converter of claim 9, further comprising:
a processing circuit, coupled to the control circuit and the power stage, configured to receive the control signal and generate a plurality of driving signals for controlling a plurality of switches in the power stage according to the control signal.

13. The power converter of claim 9, further comprising:
an error amplifier, coupled to the control circuit, configured to output the first error voltage to the control circuit.

14. The power converter of claim 13, wherein the error amplifier is further coupled to the power stage, to generate the first error voltage according to the output voltage.

15. The power converter of claim 9, wherein the ramp generator changes a magnitude of the ramp voltage according to the input voltage or the output voltage.

16. The power converter of claim 9, wherein the first error voltage substantially keeps unchanged during a transition of the input voltage.
